(19) United States
(12) Patent Application Publication
(10) Pub. No.: US 2026/0111265 A1
(43) Pub. Date: Apr. 23, 2026

(54) METHOD AND APPARATUS OF WRITING FILE, ELECTRONIC DEVICE, COMPUTER PROGRAM AND STORAGE MEDIUM

(71) Applicant: SAMSUNG ELECTRONICS CO., LTD., Suwon-si (KR)

(72) Inventors: Xing HE, Xi'an (CN); Yiwen ZHANG, Xi'an (CN); Hui QI, Xi'an (CN)

(73) Assignee: SAMSUNG ELECTRONICS CO., LTD., Suwon-si (KR)

(21) Appl. No.: 18/947,974

(22) Filed: Nov. 14, 2024

(30) Foreign Application Priority Data
Oct. 17, 2024 (CN) 202411455617.2

(51) Int. Cl. G06F 9/50; G06F 12/02

(52) U.S. Cl. CPC G06F 9/5016; G06F 12/0253

(57) ABSTRACT

A method of writing a file, including acquiring a plurality of target files to be written; determining, for each of the plurality of target files, a feature value associated with a file failure time of each of the plurality of target files; allocating a reclaim circuit handler to each target file based on the feature value of each target file such that differences between failure times of individual files contained in a reclaim circuit pointed to by the reclaim circuit handler are less than a preset threshold value, each reclaim circuit handler being one of a preset plurality of reclaim circuit handlers; writing each target file into the reclaim circuit pointed to by the reclaim circuit handler allocated to each target file.

### CROSS REFERENCE TO RELATED APPLICATION

This application is based on and claims priority to Chinese Patent Application No. 202411455617.2 filed on Oct. 17, 2024, in the China National Intellectual Property Administration, the disclosure of which is incorporated herein in its entirety by reference.

### BACKGROUND

The present disclosure relates to a computer technology field, and in particular, to a method and apparatus of writing file, an electronic device, a computer program and a storage medium.

Flexible Data Placement (FDP) is a newly approved nonvolatile memory express (NVMe) specification. A FDP Solid State Drive (SSD) is configured with a number of Reclaim Units (RUs), and multiple RUs may be organized into a Reclaim Group (RG). Moreover, each RG may have one or more Reclaim Unit Handles (RUHs), and each RUH may point to a RU in the RG.

An important factor affecting the service life and performance of a SSD is Write Amplification (WA, which may also be referred to as WAF). A main reason for generating write amplification is due to fragmentation of data storage. The fragmentation may mean that various files with different degrees of hotness and coldness (e.g., how frequently a file is accessed) at the same time are include in a RU. In this case, when performing Garbage Collection (GC), if there is still valid data in a current RU, it is necessary to move the valid data to a new RU first, and then erase invalid data in the RU. Moving the valid data to the new RU may generate write amplification. For example, it is assumed that a write amplification factor is 5, for every 4 KB of data written by a host, 20 KB of data will eventually be written in a RU. Therefore, due to the fragmentation of data storage, there is an increase in write overhead, thereby leading to inefficient memory usage.

### SUMMARY

The present disclosure provides a method and apparatus of writing file, an electronic device, a computer program and a storage medium, in order to at least solve the problem in the related art that fragmentation of data storage leads to incurring more write overhead.

According to an aspect of the disclosure, a method of writing a file, includes: acquiring a plurality of target files to be written; determining, for each of the plurality of target files, a feature value associated with a file failure time of each of the plurality of target files; allocating a reclaim circuit handler to each target file based on the feature value of each target file such that differences between failure times of individual files contained in a reclaim circuit pointed to by the reclaim circuit handler are less than a preset threshold value, each reclaim circuit handler being one of a preset plurality of reclaim circuit handlers; and writing each target file into the reclaim circuit pointed to by the reclaim circuit handler allocated to each target file.

According to an aspect of the disclosure, an apparatus of writing a file, includes: a memory configured to store one or more instructions; and a processor operatively coupled to the memory and configured to execute the one or more instructions stored in the memory, wherein the one or more instructions, when executed by the processor, cause the apparatus to: acquire a plurality of target files to be written, determine, for each of the plurality of target files, a feature value associated with a file failure time of each of the plurality of target files, allocate a reclaim circuit handler to each target file based on the feature value of each target file, such that differences between failure times of individual files contained in a reclaim circuit pointed to by the reclaim circuit handler are less than a preset threshold value, each reclaim circuit handler being one of a preset plurality of reclaim circuit handlers, and write each target file into the reclaim circuit pointed to by the reclaim circuit handler allocated to each target file.

According to an aspect of the disclosure, an electronic device includes: a memory storing one or more instructions; and a processor operatively coupled to the memory and configured to execute the one or more instructions stored in the memory, wherein the one or more instructions, when executed by the processor, cause the electronic device to: acquire a plurality of target files to be written, predict, for each of the plurality of target files, a file failure time of each of the plurality of target files, allocate a reclaim circuit handler to each target file based on the file failure time of each target file such that differences between failure times of individual files contained in a reclaim circuit pointed to by the reclaim circuit handler are less than a preset threshold value, each reclaim circuit handler being one of a preset plurality of reclaim circuit handlers, and write each target file into the reclaim circuit pointed to by the reclaim circuit handler allocated to each target file.

According to an aspect of the disclosure, a non-transitory computer readable storage medium, having instructions stored therein, which when executed by a processor of an electronic device, cause the electronic device to execute a method including: acquiring a plurality of target files to be written; determining, for each of the plurality of target files, a feature value associated with a file failure time of each of the plurality of target files; allocating a reclaim circuit handler to each target file based on the feature value of each target file such that differences between failure times of individual files contained in a reclaim circuit pointed to by the reclaim circuit handler are less than a preset threshold value, each reclaim circuit handler being one of a preset plurality of reclaim circuit handlers; writing each target file into the reclaim circuit pointed to by the reclaim circuit handler allocated to each target file.

The technical solutions provided by the embodiments of the present disclosure bring at least the following beneficial effects:

In the present disclosure, since the differences between the failure times of the individual files contained in the reclaim unit pointed to by the same reclaim unit handle may be smaller than the preset threshold value, i.e., since the failure times of the individual files written into the same RU may be approximately same as far as possible, synchronous erasure of the individual files contained in the same RU may be realized when garbage collection is performed, and write amplification due to simultaneous existence of both invalid and valid data in the same RU may be avoided. Thus, the method provided by the present disclosure may reduce the degree of fragmentation of the files contained in the RU, which in turn reduces write overhead.

It is to be understood that both the foregoing general description and the following detailed description are exemplary and explanatory only and are not restrictive of the present disclosure.

### BRIEF DESCRIPTION OF DRAWINGS

The accompanying drawings, which are incorporated in and constitute a part of the specification, illustrate example embodiments consistent with the present disclosure, and together with the specification serve to explain the principles of the present disclosure and do not unduly limit the disclosure.

FIG. 1 is a schematic diagram illustrating an reclaim group ;

FIG. 2 is a schematic diagram illustrating a RUH of a PI type and a RUH of a II type for data moving;

FIG. 3 is a flowchart illustrating a method of writing file according to one or more exemplary embodiments of the present disclosure;

FIG. 4 is a diagram illustrating a distribution of error values between lifetimes of files predicted by a random forest model and real lifetimes of the files according to one or more exemplary embodiments of the present disclosure;

FIG. 5 is a schematic diagram illustrating different degrees of mixing of hotness and coldness of data resulting from allocating different types of RUHs according to one or more exemplary embodiments of the present disclosure;

FIG. 6 is a schematic diagram illustrating various feature values according to one or more exemplary embodiments of the present disclosure;

FIG. 7 is a schematic diagram illustrating writing a target file E to RUs pointed to by different RUHs according to one or more exemplary embodiments of the present disclosure;

FIG. 8 is a schematic diagram illustrating a compaction process of a RocksDB file according to one or more exemplary embodiments of the present disclosure;

FIG. 9 is a schematic diagram illustrating lifetimes of files at different layers according to one or more exemplary embodiments of the present disclosure;

FIG. 10 is a schematic diagram illustrating a number of writes of a file of MySQL type and a file of PostgreSQL type according to one or more exemplary embodiments of the present disclosure;

FIG. 11 is a schematic diagram illustrating different space utilization resulting from allocating different types of RUHs according to one or more exemplary embodiments of the present disclosure;

FIG. 12 is a flowchart illustrating a specific implementation of a method of writing file according to one or more exemplary embodiments of the present disclosure;

FIG. 13 is a block diagram illustrating an apparatus of writing file according to one or more exemplary embodiments of the present disclosure;

FIG. 14 is a block diagram illustrating an electronic device according to one or more exemplary embodiments of the present disclosure.

FIG. 15 is a block diagram of an example computer system, in accordance with embodiments of the present disclosure.

### DETAILED DESCRIPTION

In order to make those skilled in the art better understand the technical solutions of the present disclosure, the technical solutions in the embodiments of the present disclosure will be clearly and completely described below with reference to the accompanying drawings.

It should be noted that the terms “first”, “second” and the like in the description and claims of the present disclosure and the above drawings are used to distinguish similar objects, and are not necessarily used to describe a specific order or sequence. It is to be understood that the data used in this way may be interchanged under appropriate circumstances so that the embodiments of the disclosure described herein can be practiced in orders other than those illustrated or described herein. The implementations described in the following examples are not intended to represent all implementations consistent with the present disclosure. Rather, they are merely examples of apparatus and methods consistent with some aspects of the present disclosure, as recited in the appended claims.

It should be noted here that “at least one of several items” in the present disclosure means including three parallel situations of “any one of the several items”, “a combination of any of the several items”, “the whole of the several items”. For example, “including at least one of A and B” includes the following three parallel situations: (1) including A; (2) including B; (3) including A and B. Another example is “executing at least one of operation 1 and operation 2”, which means the following three parallel situations: (1) executing operation 1; (2) executing operation 2; (3) executing operation 1 and operation 2.

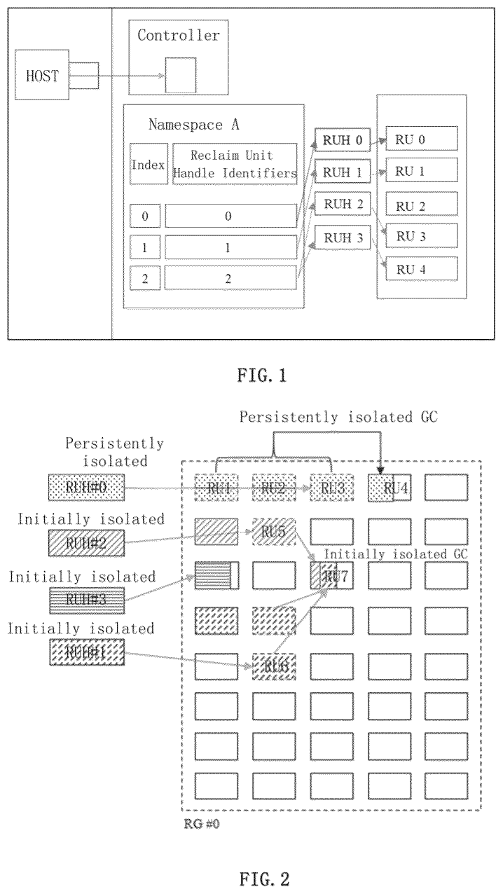

In one or more examples, a FDP SSD is configured with a number of Reclaim Units (RUs), and a plurality of RUs may be organized into a Reclaim Group (RG). Each RG may have one or more Reclaim Unit Handles (RUHs), and each RUH may point to a RU in the RG. In one or more examples, a RU may be referred to as a reclaim circuit, and a RUH may be referred to as a reclaim circuit handler. FIG. 1 is a schematic diagram illustrating an example reclaim group. Referring to FIG. 1, four RUHs are illustrated, a RUH0, a RUH1, a RUH2 and a RUH3, respectively, and five RUs are also illustrated, a RU0, a RU1, a RU2, a RU3, and a RU4, respectively. Wherein the RUH0 may point to the RU0, the RUH1 may point to the RU1, the RUH2 may point to the RU3, and the RUH3 may point to the RU4.

The RUHs may be up to 2¹⁶=65536, and a host may use the RUH to place data in the RU. When writing data to a pointed RU, if the current RU is not filled, the data may be written to that RU. If the current RU is filled, a controller may assign the RUH to another empty RU. If the current RU is written over capacity, the current RU may be filled first and the RUH may be assigned to another empty RU, and then the remaining data may be written to the new RU.

Further, the RUH may be categorized into one of two types, which are a Persistently Isolated (PI) type and an Initially Isolated (II) type. Among them, a RUH of the PI type only allows data to be moved (Garbage Collection, GC) into a RU pointed to by a same RUH. This type of moving ensures smaller write amplification, but the space utilization of the RU is lower. A RUH of the II type allows data to be moved (GC) into a RU pointed to by a RUH of the same type. In this case, the space utilization of the RU is higher, but the write amplification is higher as well.

FIG. 2 is a schematic diagram illustrating an example RUH of a PI type and a RUH of a II type for moving data. Referring to FIG. 2, a RUH#0 of the PI type is illustrated, the RUH#0 may point to a RU1, a RU2, a RU3 and a RU4, and three RUHs of the II type are also illustrated, a RUH#1, a RUH#2, and a RUH#3, respectively. Among them, the RUH#1 may point to a RU6 and the RUH#2 may point to a RU5.

When moving data within the RU1, the RU2 and the RU3, the data needs to be moved to the RU4 pointed to by the same RUH#0. When moving data within the RU5, the RU6, the data be moved to a RU7 pointed by a RUH of the same type(e.g., the II type). It may be seen that a degree of mixing of data with different degrees of hotness and coldness in the same RU is low because the RUH of the PI type only allows the data to be moved (GC) into the RU pointed to by the same RUH, and the degree of mixing of data with different degrees of hotness and coldness in the same RU is high because the RUH of the II type allows the data to be moved (GC) into the RU pointed to by a RUH of the same type.

A main reason for generating write amplification is fragmentation of data storage. In one or more examples, fragmentation may mean that various files with different degrees of hotness and coldness at the same time are included in a RU. In this case, when performing GC, if there is still valid data in the current RU, it is necessary to move the valid data to a new RU first, and then erase invalid data in the RU. Moving the valid data to the new RU may disadvantageously generate write amplification. It may be seen that due to the fragmentation of data storage, it leads to incurring more write overhead.

In order to solve the above problems, the present disclosure provides methods and apparatuses of writing file, electronic devices, computer programs, and storage media, make the differences in the failure times of the individual files contained in the reclaim unit pointed to by the same reclaim unit handle smaller than the preset threshold(e.g., make the failure times of the individual files written into the same RU approximately same as far as possible). Therefore, the individual files contained in the same RU may be synchronously erased when garbage collection is performed, avoiding the phenomenon of write amplification due to the simultaneous existence of invalid data and valid data in the same RU. It may be seen that the method of writing file provided in the present disclosure may reduce the degree of fragmentation of the files contained in the RU, which in turn may reduce the write overhead.

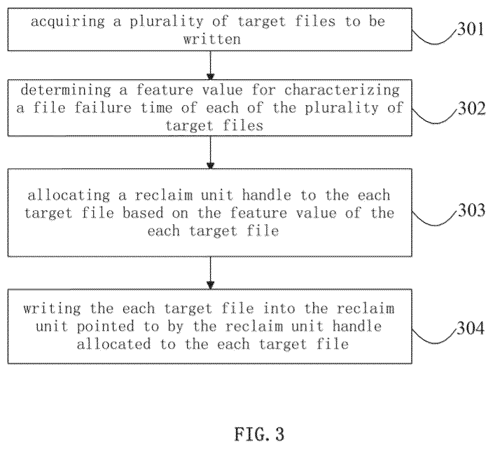

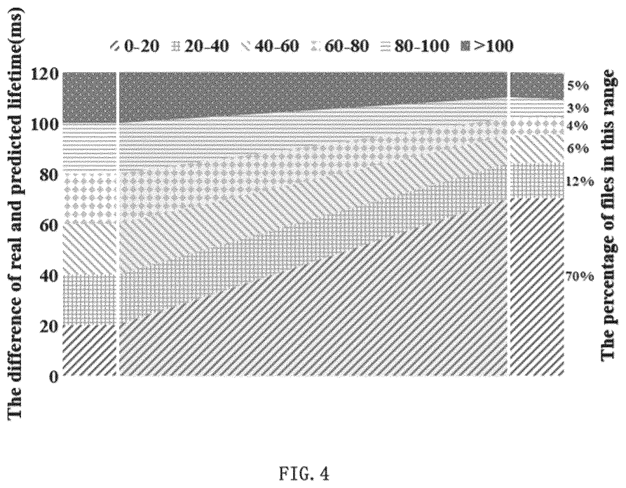

FIG. 3 is a flowchart illustrating a method of writing file according to one or more exemplary embodiments of the present disclosure.

Referring to FIG. 3, in operation 301, a plurality of target files to be written may be acquired, wherein the target file may be a file generated during use of an application (App). The method of writing a file provided in the present disclosure may be accomplished by four modules, which may be a monitor, a pre-allocator, a re-allocator, and a divider.

In one or more examples, the monitor may be used to periodically detect all characteristics of a target file and record its information in a file record table. The pre-allocator may be used to predict a lifetime of a target file of a short-time open file type. The re-allocator may be used to divide target files into different groups based on USM values of the target files. The divider may be used to assign specific RUHs to the divided different groups of target files. In one or examples, the monitor module, pre-allocator module, the re-allocator module, and the divider module may be implemented by individual circuitry (e.g. ASIC configured to perform the functions of a respective module) or by one or processors.

In operation 302, a feature value for characterizing a file failure time may be determined for each of the plurality of target files. In one or more examples, the file failure time is a sum of a creation time of the file and a lifetime of the file.

In one or more examples, a “file lifetime” (e.g., lifetime of the file) may refer to a length of time experienced by a file from a time it is created until a time it is deleted. The “lifetime” of a file may be used to characterize a degree of hotness and coldness of the file, in which the shorter the lifetime of the file is, it indicates that the file is hotter; the longer the lifetime of the file is, it indicates that the file is less hot(e.g., colder. If two files have a same failure time, it means that the two files will be invalid at the same time. In one or more examples, the hotness and coldness of a data may refer to how frequently the data is accessed. For example first data that is accessed more frequently than second data may have a higher degree of hotness than the second data, and vice versa, the second data may have a higher degree of coldness than the first data.

In operation 303, a reclaim unit handle may be allocated to each target file based on the feature value of each target file so that differences in failure times of individual files contained in a reclaim unit pointed to by the reclaim unit handle are less than a preset threshold value, and each reclaim unit handle may be one of a preset plurality of reclaim unit handles.

In this manner, since the differences between the failure times of the individual files contained in the reclaim unit pointed to by the same reclaim unit handle may be smaller than the preset threshold value (e.g., since the failure times of the individual files written into the same RU may be approximately same as far as possible), synchronous erasure of the individual files contained in the same RU may be advantageously realized when garbage collection is performed, and write amplification due to simultaneous existence of both invalid and valid data in the same RU may be avoided. The degree of fragmentation of the files contained in the RU is reduced, which in turn reduces write overhead.

According to one or more exemplary embodiments of the present disclosure, a total number of the preset plurality of reclaim unit handles may be N. Before acquiring the plurality of target files to be written, in response to a setting input from a user, a number of reclaim unit handles whose handle type is a PI type may be set to d, and a number of reclaim unit handles whose handle type is an II type may be set to (N-d). The parameters N and d may be positive integers.

In one or more examples, it is assumed that the total number of reclaim unit handles is 10, the user may decide proportions of RUHs of various types according to his or her needs. For example, the user may set the number of reclaim unit handles of the PI type to be 5 and set the number of reclaim unit handles of the II type to be 5. In one or more examples, the user may set the number of reclaim unit handles of the PI type to be 6 and set the number of reclaim unit handles of the II type to be 4, and so on. In this manner, since the user may set the proportions of RUHs of various types according to the actual situations, the autonomy and flexibility of setting the proportions of RUHs of various types is improved.

According to one or more exemplary embodiments of the present disclosure, a file type of each of the plurality of target files may also be determined, wherein the file type may include a short-time open file type and a long-time open file type. A reclaim unit handle may then be allocated to each target file based on the feature value and the file type of each target file. Exemplarily, a file of the “short-time open file type” may be a file of a Rocksdb type, and a file of the “long-time open file type” may be a file of a MySQL type. As understood by one of ordinary skill in the art, the Rocksdb file may refer to a file stored in an embedded database for key-value data. As understood by one of ordinary skill in the art, the MySQL type may refer to an internal systems file which stores the metadata used to form a table definition (column names and other relationship metadata) of a MySQL.

According to one or more exemplary embodiments of the present disclosure, the file type of each target file may be defaulted to the short-time open file type, and furthermore, whether the each target file is in an open state may be detected every preset time interval T. In a case where a target file is detected to be in the open state, the file type of the target file may be converted from the short-time open file type to the long-time open file type.

According to one or more exemplary embodiments of the present disclosure, in a case where a file type of a target file is the short-time open file type, a predicted lifetime of each target file of the short-time open file type may be obtained by inputting the feature value of the each target file into a random forest model. For example, the pre-allocator may use the random forest model to predict the lifetime of the each target file of the short-time open file type based on the feature value of the each target file. The failure time of the each target file may then be calculated based on a creation time and the predicted lifetime of each target file. As previously mentioned, the failure time of the target file may be the sum of the creation time of the target file and the predicted lifetime of the target file.

Next, a reclaim unit handle of a persistently isolated type may be allocated to each target file based on the failure time of each target file and a failure time of a currently existing file in a reclaim unit pointed to by each of the preset plurality of reclaim unit handles. Wherein the reclaim unit handle of the persistently isolated type permits allows for a file to be moved from a first reclaim unit pointed to by a reclaim unit handle of the persistently isolated type to a second reclaim unit pointed to by the reclaim unit handle of the persistently isolated type. That is, the reclaim unit handle of the PI type only allows data to be moved between RUs pointed to by the same RUH.

It should be noted that as a common and effective machine learning algorithm, the random forest model has a low computational complexity, which reduces additional overhead and ensures prediction accuracy. In one or more examples, a random forest model may be a machine learning algorithm that combines the output of multiple decision trees to reach a result. For example, the random forest model may be an ensemble learning method for classification, regression and other tasks that operates by constructing a multitude of decision trees at training time. For classification tasks, the output of the random forest may be the class selected by the most trees. For regression tasks, the mean or average prediction of the individual trees is returned.

FIG. 4 is a diagram illustrating a distribution of error values between lifetimes of files predicted by a random forest model and real lifetimes of the files according to one or more exemplary embodiments of the present disclosure. Referring to FIG. 4, a number of files whose errors between the predicted lifetimes and the real lifetimes are within 20 ms accounts for 70% of a total number of files; and a number of files whose errors are within 60 ms accounts for 88% of the total number of files. As illustrated in FIG. 4, the prediction accuracy of the random forest model is effectively verified.

According to the embodiments of the present disclosure, the random forest model may be used to accurately predict the lifetime of a file, and the failure time of each target file may be calculated based on the creation time and the predicted lifetime of each target file, which in turn the allocation of RUHs may be managed based on the failure time of each target file. It may be ensured that the degree of mixing of data in the same RU is reduced, which in turn reduces the GC overhead to achieve reduced write amplification (WAF) and improved write performance and lifetime of the SSD.

Further, when training the random forest model, the feature values of the files may be input into the model as samples, and real lifetimes of the files may be used as labels. In this manner, after the random forest model outputs the predicted lifetime, a value of a loss function may be calculated based on the predicted lifetime and the real lifetime, and parameters of the model may be adjusted based on the calculated value of the loss function to train the model.

According to one or more exemplary embodiments of the present disclosure, for each of a first number of reclaim unit handles of the PI type contained in the preset plurality of reclaim unit handles, a mean square error between the failure time of each target file and a failure time of a currently existing file in a reclaim unit pointed to by the each reclaim unit handle of the PI type may be calculated. Then, a corresponding reclaim unit handle of the PI type with the lowest mean square error may be determined for each target file, among the first number of reclaim unit handles of the persistently isolated type. Next, the corresponding reclaim unit handle of the persistently isolated type with the lowest mean square error may be allocated to each target file.

In one or more examples, in calculating the above mean square error, it is assumed that the failure time of the target file is t, and that there are three RUHs of the PI type, RUH1, RUH2 and RUH3, respectively. For RUH1, it is assumed that there are three existing files in a reclaim unit pointed to by RUH1, and that failure times of these three existing files are t1, t2, t3, respectively. The mean square error corresponding to RUH1 may be(t−t1)²+(t−t2)²+(t−t3)². Similarly, mean square errors corresponding to RUH2 and RUH3 may be calculated.

In this manner, it may be ensured that the failure times of the individual files within the RU pointed to by each reclaim unit handle of the PI type are close to each other, and thus a reduction in the degree of fragmentation of data storage may be realized.

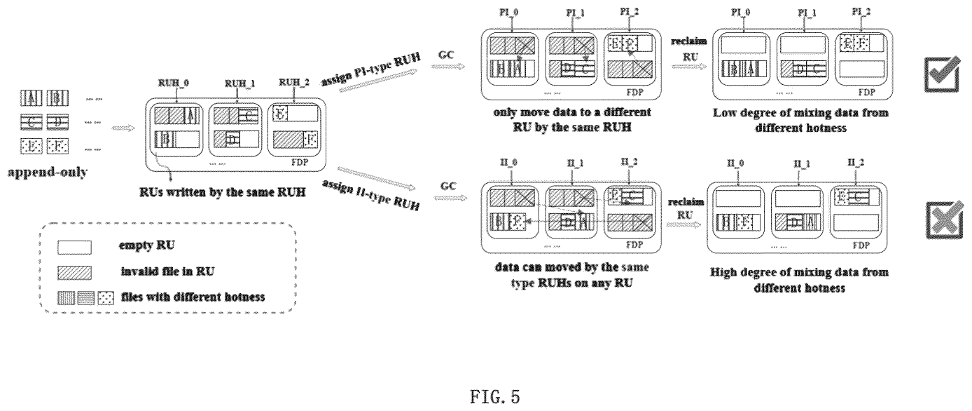

It should be noted that since the present disclosure allocates RUHs on a file basis, and a short-time open file is almost never changed, the lifetime of the short-time open file and the lifetime of data contained in the short-time open file are consistent. FIG. 5 is a schematic diagram illustrating different degrees of mixing of hotness and coldness of data resulting from allocating different types of RUHs according to one or more exemplary embodiments of the present disclosure.

Referring to FIG. 5, it is assumed that there are a total of six target files, a target file A, a target file B, a target file C, a target file D, a target file E and a target file F, respectively. It is assumed that the target file A and the target file B have a same degree of hotness, and that patterns corresponding to the target file A and the target file B are both “vertical bar” patterns. It is assumed that the target file C and the target file D have a same degree of hotness, and that patterns corresponding to the target file C and the target file D are both “horizontal bar” patterns. It is assumed that the target file E and the target file F have a same degree of hotness, and that patterns corresponding to the target file E and the target file F are both “black dot” patterns.

Since the target file A and the target file B have the same degree of hotness, the target file A and the target file B may be stored in a RU pointed to by a same RUH_0. Similarly, the target file C and the target file D may be stored in a RU pointed to by a same RUH_1; and the target file E and the target file F may be stored in a RU pointed to by a same RUH 2.

Further, if the type of the allocated RUH is the PI type, when data moving (GC) is performed, the target file A may only be moved from the current RU to another RU pointed to by the same reclaim unit handle (PI_0); similarly, the target file C may only be moved from the current RU to another RU pointed to by the same reclaim unit handle (PI_1); and the target file F may only be moved from the current RU to another RU pointed to by the same reclaim unit handle (PI_2). Thus, after data erasure, the target file A and the target file B with the same or similar degree of hotness are stored in a same RU, the target file C and the target file D with the same or similar degree of hotness are stored in a same RU, and the target file E and the target file F with the same or similar degree of hotness are stored in a same RU. The characteristic of the RUH of the PI type that only allows data to be moved between the RUs pointed to by the same RUH” ensures that the mixing degree of data with different degrees of hotness is low, and therefore, the RUH of the PI type is more advantageous in reducing write amplification. In one or more examples, two files may be considered to have a similar degree of hotness if a difference in the levels of hotness between the two files is within a threshold.

In one or more examples, if the type of the allocated RUH is of the II type, when data moving (GC) is performed, the target file A may be moved from the current RU to a RU pointed to by a RUH (II_1) of the same type as a RUH (II_0). Similarly, the target file C may be moved from the current RU to a RU pointed to by a RUH (II_2) of the same type as the RUH (II_1); and, the target file F may be moved from the current RU to a RU pointed to by the RUH (II_0) of the same type as the RUH (II_2). Thus, after data erasure, the target file B and the target file F having different degrees of hotness are stored in a same RU, the target file A and the target file D having different degrees of hotness are stored in a same RU, and the target file C and the target file E having different degrees of hotness are stored in a same RU. It may be seen that the characteristic of the RUH of the II type that allows the file to be moved between RUs pointed to by RUHs of the same type may causes that the mixing degree of data with different degrees of hotness is high, and thus the RUH of the II type has a disadvantage in reducing write amplification compared to the RUH of the PI type.

According to one or more exemplary embodiments of the present disclosure, in the case where a file type of a target file is the short-time open file type, the feature value of the target file may include at least one of: a creation time of the target file, a size of the target file, a number of files of which open times are close to an open time of the target file under each of the preset plurality of reclaim unit handles, an average lifetime of files of which file types are same as the file type of the target file and which have been deleted under the each preset reclaim unit handle.

In one or more examples, monitor may continuously extract information of all files and update and store their feature values in the file record table. Due to different attributes of the short-time open file type and the long-time open file type, the monitor needs to extract the corresponding feature values based on the file types. Moreover, most of database files that are updated in place are the long-time open file types, and most of database files that are appended are short-time open file types. In one or more examples, the monitor may extract information of all files, or a predetermined set of files, at periodic intervals.

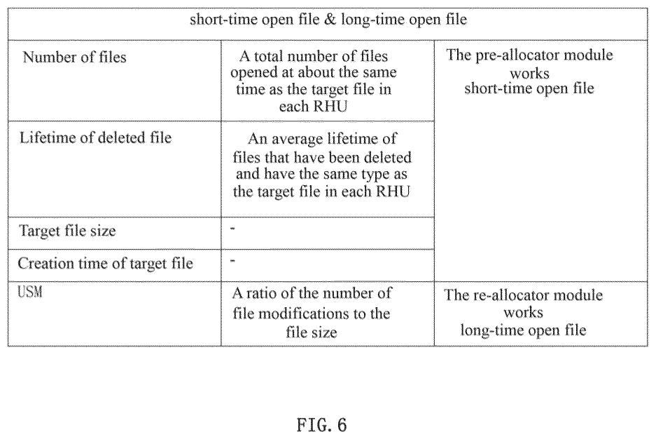

FIG. 6 is a schematic diagram illustrating various feature values according to one or more exemplary embodiments of the present disclosure. Referring to FIG. 6, feature values corresponding to each file type of a “short-time open file type” and a “long-time open file type” are shown. Furthermore, the pre-allocator mainly functions in predicting a lifetime of a target file of the “short-time open file type”, and the re-allocator mainly functions in grouping USMs corresponding to target files of the “long-time open file type”.

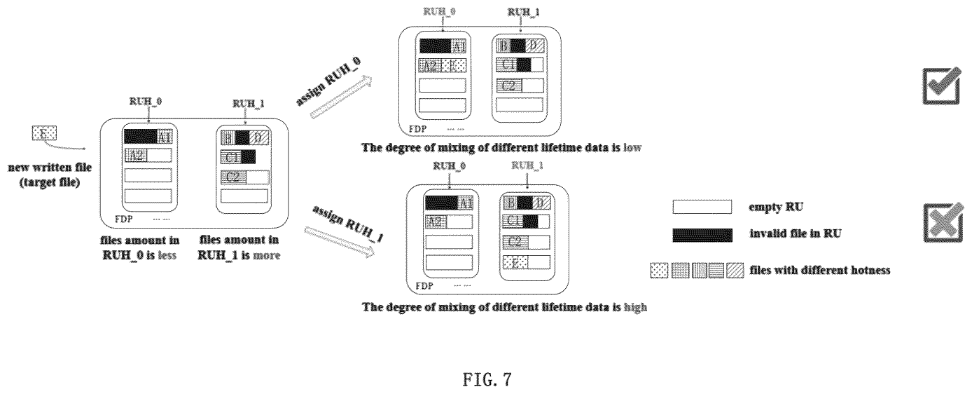

FIG. 7 is a schematic diagram illustrating writing a target file E to RUs pointed to by different RUHs according to one or more exemplary embodiments of the present disclosure. Referring to FIG. 7, a file A1 and a file A2 may be two different components contained in a same file, and therefore, the file A1 and the file A2 have a same hotness, and the file A1 and the file A2 are currently stored in a RU pointed to by a RUH_0. A file C1 and a file C2 may be two different components contained in a same file, and therefore, the file C1 and the file C2 have a same hotness, and the file C1 and the file C2 are currently stored in a RU pointed to by a RUH_1. A file B and a file D are currently stored in the RU pointed to by the RUH_1.

The target file E, which is to be written to a RU, the file B, the file D, the file A1 and the file A2, the file C1 and the file C2, all have different degrees of hotness and coldness among each other, Therefore, referring to FIG. 7, different patterns may be used to represent the files with different degrees of hotness and coldness, respectively.

Further, the upper graph in FIG. 7 represents writing the target file E into the RU pointed to by the RUH_0; and the lower graph in FIG. 7 represents writing the target file E into the RU pointed to by the RUH_1. Comparing the two situations, it may be seen that: (i) writing the target file E into the RU pointed by the RUH_0 leads to a lower degree of mixing of hotness and coldness of data; and (ii) writing the target file E into the RU pointed by the RUH_1 leads to a higher degree of mixing of hotness and coldness of data. It should be noted that data of a same file may be written to different blocks simultaneously, especially when the file is relatively large. Therefore, reducing the degree of mixing of file data written simultaneously may realize better separation of data where files with the same or similar degree of hotness are more likely to be stored together.

In one or more examples, for the feature value of “an average lifetime of deleted files”: files of a same type have similar lifetimes, and a lifetime of a deleted file is known. Therefore, the average lifetime of deleted files of the same type may be used to predict a lifetime of a target file.

In one or more examples, for the feature value of “a size of a target file”: a size of a file may reflect a lifetime of the file to some extent. For example, a media file is generally larger and colder, while a directory file is smaller and hotter.

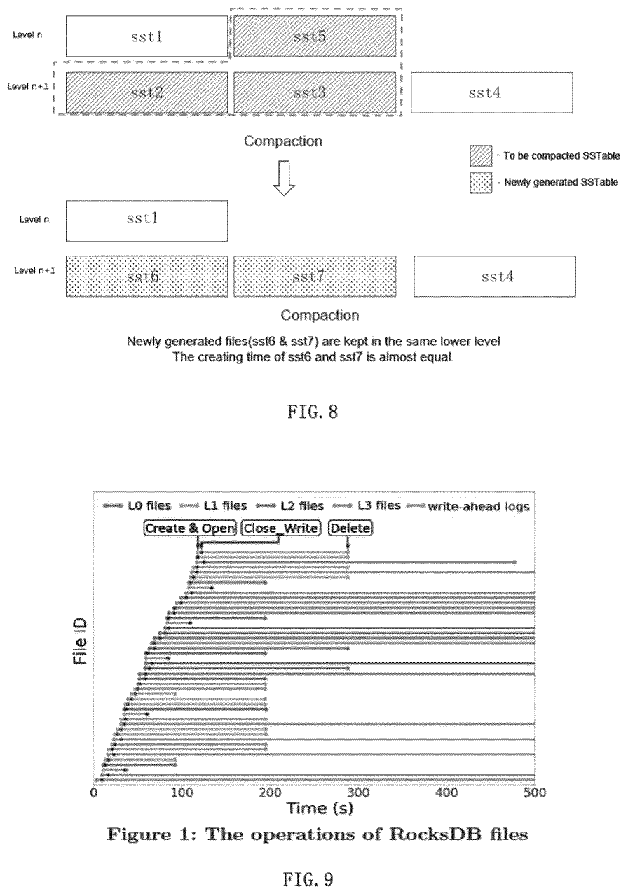

In one or more examples, for the feature value of “a creation time of a target file”: using a RocksDB file as one or more examples, FIG. 8 is a schematic diagram illustrating a compaction process of a RocksDB file according to one or more exemplary embodiments of the present disclosure. Referring to FIG. 8, a total of two layers are illustrated, a level(n) and a level(n+1), respectively. After deleting a sst2, a sst3 and a sst5, newly generated files sst6 and sst7 in a set of compactions are written at the same time into the same level level(n+1). FIG. 9 is a schematic diagram illustrating lifetimes of files at different layers according to one or more exemplary embodiments of the present disclosure. Referring to FIG. 9, example lifetimes of files in four layers L0, L1, L2, and L3 are illustrated. As may be seen, lifetimes of files in a same layer are relatively similar, and the larger a level of a layer is, the lifetime of a file in that layer is generally larger. As mentioned above, the newly generated files in the set of compactions are written to the same layer at almost the same time. Therefore, the creation time of the target file may be used to reflect the lifetime of the target file.

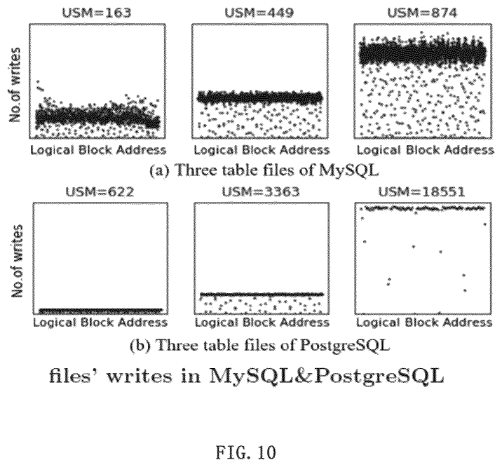

In one or more examples, for the feature value of “a USM”: a write request to update a file in place may be random, data is updated inside the file, and a modification of the file is also a modification of a Logic Block Address (LBA), and more data written to a LBA often means a shorter lifetime of the data written to that LBA. FIG. 10 is a schematic diagram illustrating a number of writes of a file of MySQL type and a file of PostgreSQL type according to one or more exemplary embodiments of the present disclosure. Referring to FIG. 10, the graph shows that the USM is strongly correlated with a frequency of updates to data, and thus, the USM may be used to reflect the lifetime of the file, and the larger the USM is, the shorter the lifetime of the file is.

It should be noted that the “feature value” of the target file in the present disclosure is not limited to the contents listed in the above section, but may also be other contents that may be used to characterize the lifetime of the file, which will not be repeated herein, and the above embodiments are only exemplary illustrations.

According to one or more exemplary embodiments of the present disclosure, in a case where a file type of a target file is the long-time open file type, the above feature value may be a Unit Size Modification (USM), and the USM may be a ratio of a number of times the target file has been modified to a size of the target file. A plurality of USMs corresponding to the plurality of target files may be clustered using a K-mean algorithm to divide the plurality of target files into a plurality of groups. A reclaim unit handle may then be allocated for each of the plurality of groups.

The classification algorithm may be other types of classification algorithms in addition to the K-mean algorithm, and the present disclosure does not make specific limitations in this regard, and the foregoing embodiment is merely an exemplary illustration.

According to one or more exemplary embodiments of the present disclosure, a second number of reclaim unit handles of the II type among the preset plurality of reclaim unit handles may be determined. Wherein the reclaim unit handle of the II type allows for a file to be moved from a third reclaim unit pointed to by the reclaim unit handle of the II type to a fourth reclaim unit pointed to by a reclaim unit handle of a same type as the II type. That is, a RUH of the II type allows data to be moved between RUs pointed to by RUHs of a same type.

For the second number of reclaim unit handles of the II type, K of the K-mean algorithm may be set to the second number described above. Next, the plurality of USMs corresponding to the plurality of target files may be clustered using the K-mean algorithm whose K is set to the second number, to divide the plurality of target files into the second number of groups. Then, for each of the plurality of groups, a reclaim unit handle of the II type may be selected to be allocated to the each group, from the second number of reclaim unit handles of the II type.

Exemplarily, as previously described, the user may set the number of reclaim unit handles whose handle type is the II type to be (N-d), and it is assumed that these (N-d) RUHs of the II type are numbered from d+1 to N, respectively, the divider may assign the RUHs whose IDs are from d+1 to N and whose handle type is the II type to the second number of groups described above, respectively. Further, RUHs with larger IDs may be assigned for groupings with larger USM values, and RUHs with smaller IDs may be assigned for groupings with smaller USM values.

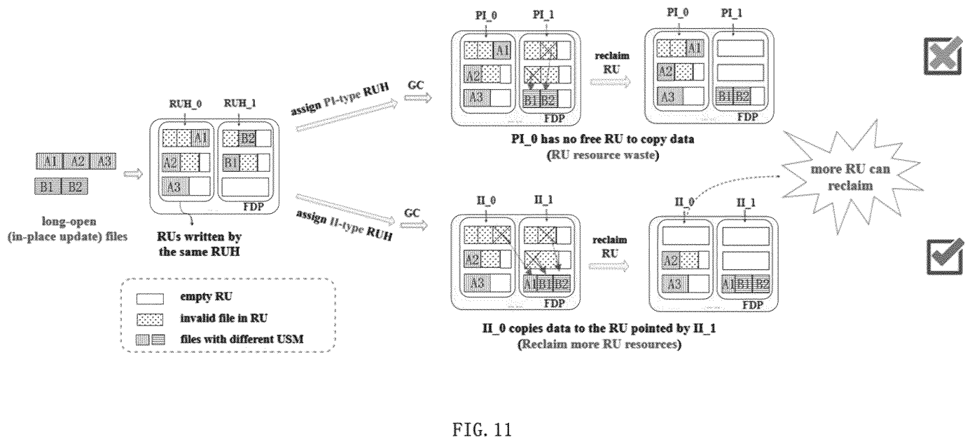

FIG. 11 is a schematic diagram illustrating different space utilization resulting from allocating different types of RUHs according to one or more exemplary embodiments of the present disclosure. Referring to FIG. 11, it is assumed that there are a total of 5 target files, a target file A1, a target file A2, a target file A3, a target file B1, a and target file B2, and the target file A1, the target file A2, and the target file A3 may be different components of a same file, and thus, the target file A1, the target file A2, and the target file A3 have a same or similar degree of hotness and coldness. Therefore, these three target files may be represented by a “vertical bar” pattern. Similarly, the target file B1, the target file B2 may be different components of a same file, therefore, the target file B1, the target file B2 have a same degree of hotness and coldness, these two target files may be represented by a “horizontal bar” pattern. The target file A1, the target file A2, and the target file A3 may be stored in a RU pointed to by a RUH_0, and the target file B1 and the target file B2 may be stored in a RU pointed to by a RUH_1.

Further, if the type of the allocated RUH is of the PI type, when data moving (GC) is performed, only the target file B1 and the target file B2 may be moved from the current RU to another RU pointed to by the same reclaim unit handle (PI_1). Thus, after data erasure, the target file B1 and the target file B2 with the same hotness are stored into the same RU, and a number of free RUs that may be reclaimed currently is two.

In one or more examples, if the type of the allocated RUH is the II type, when data moving (GC) is performed, the target file A1 may be moved from the current RU to a RU pointed to by a RUH (II_1) of the same type as a RUH (II_0); or the target file B1 and the target file B2 may be moved from the current RU to another RU pointed to by the same reclaim unit handle (II_1). In this way, after data erasure, the target file A1, the target file B1 and the target file B2, which are different degrees of hotness, are stored into the same RU, and the number of free RUs that may be reclaimed currently is three.

It may be seen that the characteristic of the RUH of the II type that allows the file to be moved between RUs pointed to by RUHs of the same type may result in a high mixing of degree of data with different degrees of hotness, and thus, the RUH of the II type has a disadvantage in reducing write amplification compared to the RUH of the PI type.

However, it is precisely due to the characteristic of the RUH of the II type that allows the file to be moved between RUs pointed to by RUHs of the same type that data may be moved in a more timely manner (e.g., it ensures that data may be vacated in a more timely manner), and RUs may be released in a more timely manner. It may be seen that, compared to the RUH of the PI type, the RUH of the II type may accelerate the release of space (e.g., accelerate the release of RU resources), and thus reduce the waste of space resources, since the RUH of the II type has more RUs available for copying (e.g., more RUs available for choosing from), when performing data moving.

In this way, in the present disclosure, when performing file writing, the characteristic of the file itself and the type of the RUH may be considered together, and a better balance may be achieved between reducing write amplification and improving space utilization.

When grouping target files, other grouping methods may be used in addition to the above grouping method. The present disclosure does not limit the specific ways of grouping a plurality of target files, and the foregoing embodiment is merely an exemplary illustration.

Referring to FIG. 3, in operation 304, each target file may be written into the reclaim unit pointed to by the reclaim unit handle allocated to each target file.

According to one or more exemplary embodiments of the present disclosure, a first proportion of target files of a short-time open file type among the plurality of target files may also be detected every preset time interval T, and/or a second proportion of target files of a long-time open file type among the plurality of target files may be detected. Then, the number d may be dynamically adjusted based on the first proportion and/or the second proportion, wherein the smaller the first proportion is, the smaller the number d may be, and the larger the second proportion is, the smaller the number d may be.

The total number of the preset plurality of reclaim unit handles is generally fixed, however, the load is dynamically changing (e.g., the proportion of the target files of the short-time open file type and the proportion of the target files of the long-time open file type may be dynamically changing over time). Therefore, the re-allocator may detect the proportions of files of various types every T seconds, and may in turn dynamically adjust d based on the proportions of files of the various types (e.g., dynamically adjust the number of RUHs of the PI type and the number of RUHs of the II type). In this way, by flexibly adjusting the number of RUHs of each type based on the number proportions of files of the various types, it may be ensured that RUHs of various types may satisfy the actual file writing demand, avoiding the phenomenon that RUH of one type is in short supply while another type of RUH is in surplus, and it may be ensured that the RUH resources are reasonably utilized.

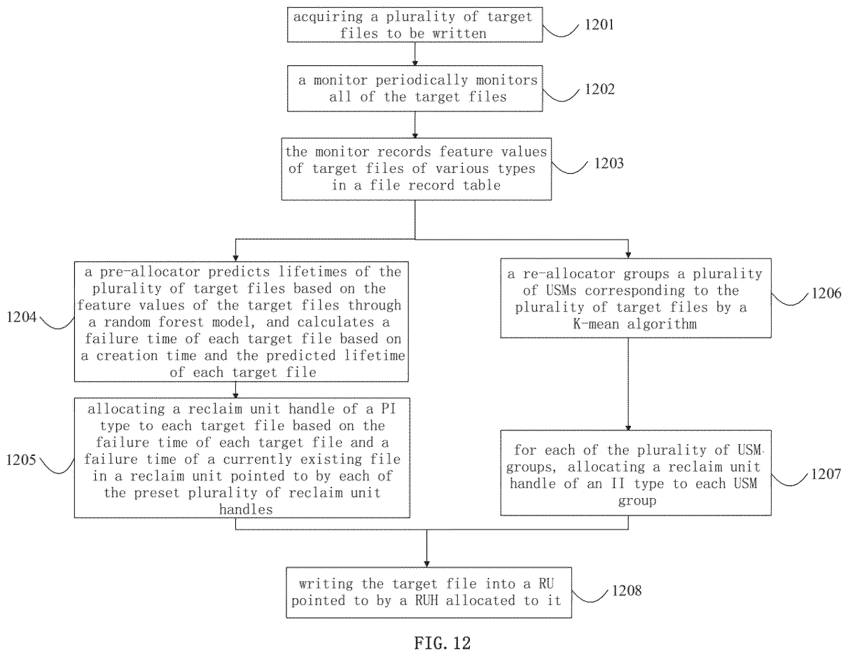

FIG. 12 is a flowchart illustrating a specific implementation of a method of writing file according to one or more exemplary embodiments of the present disclosure.

In operation 1201, a plurality of target files to be written are acquired, wherein the target file may be a file generated in a process of using an application.

In operation 1202, a monitor periodically monitors all of the target files.

In operation 1203, the monitor records feature values of target files of various types in a file record table.

In one or more examples, for a target file of a short-time open file type, the feature value thereof may include at least one of: a creation time of the target file, a size of the target file, a number of files of which open times are close to an open time of the target file under each of the preset plurality of reclaim unit handles, an average lifetime of files of which file types are same as the file type of the target file and which have been deleted under the each preset reclaim unit handle.

For a target file of a long-time open file type, the feature value thereof may be a unit size modification (USM), which may be a ratio of a number of times the target file has been modified to a size of the target file.

In operation 1204, a pre-allocator predicts lifetimes of the plurality of target files based on the feature values of the target files through a random forest model, and calculates a failure time of each target file based on a creation time and the predicted lifetime of each target file.

In operation 1205, based on the failure time of each target file and a failure time of a currently existing file in a reclaim unit pointed to by each of the preset plurality of reclaim unit handles, a reclaim unit handle of a PI type is allocated to each target file.

In operation 1206, a re-allocator groups a plurality of USMs corresponding to the plurality of target files by a K-mean algorithm, such that differences between the USMs of the target files within each group are all relatively small (e.g., the expiration times, and the failure times of the target files within each group are relatively close to each other).

In operation 1207, for each of the plurality of USM groups, a reclaim unit handle of an II type is allocated to each USM group.

In operation 1208, the target file is written into a RU pointed to by a RUH allocated to it.

In the present disclosure, the adaptation and optimization of the FDP, mainly in the form of software, may ensure improvement of the overall quality of service as well as cost reduction. Moreover, when performing file writing, the characteristic of the file itself may be considered in conjunction with the type of RUH, and a better balance may be achieved between reducing write amplification and improving space utilization.

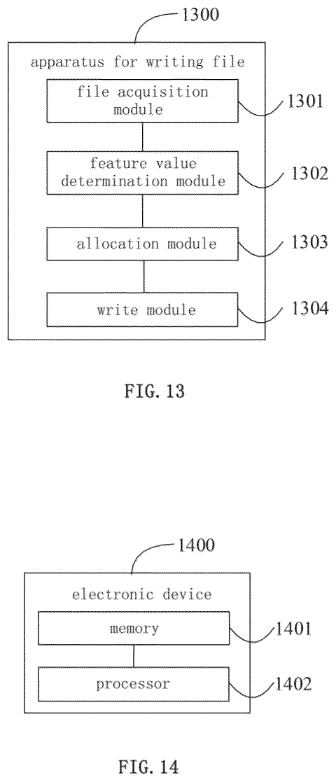

FIG. 13 is a block diagram illustrating an apparatus of writing a file according to one or more exemplary embodiments of the present disclosure.

Referring to FIG. 13, the apparatus 1300 of writing a file may include a file acquisition module 1301, a feature value determination module 1302, an allocation module 1303 and a write module 1304. Each of the modules may be implemented by individual circuitry, or by one or more processors.

The file acquisition module 1301 may acquire a plurality of target files to be written, wherein the target file may be a file generated during use of an application (App).

The feature value determination module 1302 may determine a feature value for characterizing a file failure time of each of the plurality of target files. Wherein, the file failure time is a sum of a creation time of a file and a lifetime of the file.

It should be noted that a “file lifetime” may refer to a length of time experienced by a file from a time it is created until a time it is deleted. The “lifetime” of a file may be used to characterize a degree of hotness and coldness of the file, in which the shorter the lifetime of the file is, it indicates that the file is hotter; the longer the lifetime of the file is, it indicates that the file is less hot, i.e., colder. If two files have a same failure time, it means that the two files will be invalid at the same time.

The allocation module 1303 may allocate a reclaim unit handle to the each target file based on the feature value of the each target file, such that differences between failure times of individual files contained in a reclaim unit pointed to by the reclaim unit handle are less than a preset threshold value, each reclaim unit handle being one of a preset plurality of reclaim unit handles.

In this manner, since the differences between the failure times of the individual files contained in the reclaim unit pointed to by the same reclaim unit handle may be smaller than the preset threshold value, i.e., since the failure times of the individual files written into the same RU may be approximately same as far as possible, synchronous erasure of the individual files contained in the same RU may be realized when garbage collection is performed, and write amplification due to simultaneous existence of both invalid and valid data in the same RU may be avoided. The degree of fragmentation of the files contained in the RU is reduced, which in turn reduces write overhead.

According to one or more exemplary embodiments of the present disclosure, the above apparatus 1300 of writing file may further include a setting module.

A total number of the preset plurality of reclaim unit handles may be N.

Before acquiring the plurality of target files to be written, the setting module may also set, in response to a setting input from a user, a number of reclaim unit handles whose handle type is a PI type to d, and may set a number of reclaim unit handles whose handle type is an II type to (N-d).

Exemplarily, it is assumed that the total number of reclaim unit handles is 10, the user may decide proportions of RUHs of various types according to his or her needs. For example, the user may set the number of reclaim unit handles of the PI type to be 5 and set the number of reclaim unit handles of the II type to be 5; alternatively, the user may set the number of reclaim unit handles of the PI type to be 6 and set the number of reclaim unit handles of the II type to be 4, and so on. In this manner, since the user may set the proportions of RUHs of various types according to the actual situations, the autonomy and flexibility of setting the proportions of various types of RUHs of the various types is better.

According to one or more exemplary embodiments of the present disclosure, the above apparatus 1300 of writing file may further include a file type determination module.

The file type determination module may also determine a file type of each of the plurality of target files, wherein the file type may include a short-time open file type and a long-time open file type. The allocation module 1303 may then allocate the reclaim unit handle to the each target file based on the feature value and the file type of the each target file. Exemplarily, a file of the “short-time open file type” may be a file of a Rocks db type, and a file of the “long-time open file type” may be a file of a MySQL type.

According to one or more exemplary embodiments of the present disclosure, the above file type determination module may default the file type of the each target file to the short-time open file type, and, furthermore, may detect whether the each target file is in an open state every preset time interval T. The file type of a target file from the short-time open file type may be converted to the long-time open file type in a case where the target file is detected to be in the open state.

According to one or more exemplary embodiments of the present disclosure, in a case where the file type of a target file is the short-time open file type, the allocation module 1303 may input the feature value of the target file into a random forest model to obtain a predicted lifetime of the target file. That is, the pre-allocator may use the random forest model to predict the lifetime of the target file based on the feature value of the target file of the short-time open file type.

The allocation module 1303 may then calculate a failure time of the each target file based on a creation time and the predicted lifetime of the each target file. As previously mentioned, the failure time of the target file may be the sum of the creation time of the target file and the predicted lifetime of the target file.

Next, the allocation module 1303 may allocate a reclaim unit handle of a persistently isolated type to the each target file based on the failure time of the each target file and a failure time of a currently existing file in a reclaim unit pointed to by each of the preset plurality of reclaim unit handles. Wherein the reclaim unit handle of the persistently isolated type allows for a file to be moved from a first reclaim unit pointed to by a reclaim unit handle of the persistently isolated type to a second reclaim unit pointed to by the reclaim unit handle of the persistently isolated type. That is, the reclaim unit handle of the PI type only allows data to be moved between RUs pointed to by the same RUH.

It should be noted that as a common and effective machine learning algorithm, the random forest model has a low computational complexity, which reduces additional overhead and ensures prediction accuracy.

According to one or more exemplary embodiments of the present disclosure, for each of a first number of reclaim unit handles of the persistently isolated type contained in the preset plurality of reclaim unit handles, the allocation module 1303 may calculate a mean square error between the failure time of the each target file and a failure time of a currently existing file in a reclaim unit pointed to by the each reclaim unit handle of the persistently isolated type. The allocation module 1303 may then determine, among the first number of reclaim unit handles of the persistently isolated type, a corresponding reclaim unit handle of the persistently isolated type with the lowest mean square error for the each target file. Next, the allocation module 1303 may allocate, to the each target file, the corresponding reclaim unit handle of the persistently isolated type with the lowest mean square error. In this manner, it may be ensured that the failure times of the individual files within the RU pointed to by each reclaim unit handle of the PI type are close to each other, and thus a reduction in the degree of fragmentation of data storage may be realized.

According to one or more exemplary embodiments of the present disclosure, in the case where a file type of a target file is the short-time open file type, the feature value of the target file may include at least one of: a creation time of the target file, a size of the target file, a number of files of which open times are close to an open time of the target file under each of the preset plurality of reclaim unit handles, an average lifetime of files of which file types are same as the file type of the target file and which have been deleted under the each preset reclaim unit handle.

According to one or more exemplary embodiments of the present disclosure, in a case where a file type of a target file is the long-time open file type, the above feature value may be a unit size modification (USM), and the USM may be a ratio of a number of times the target file has been modified to a size of the target file. The allocation module 1303 may cluster a plurality of USMs corresponding to the plurality of target files using a K-mean algorithm to divide the plurality of target files into a plurality of groups. The allocation module 1303 may then allocate a reclaim unit handle to each of the plurality of groups.

It is to be noted that the classification algorithm may be other types of classification algorithms in addition to the K-mean algorithm, and the present disclosure does not make specific limitations in this regard, and the foregoing embodiment is merely an exemplary illustration.

According to one or more exemplary embodiments of the present disclosure, the allocation module 1303 may determine a second number of reclaim unit handles of an initially isolated type among the preset plurality of reclaim unit handles. Wherein the reclaim unit handle of the initially isolated type allows for a file to be moved from a third reclaim unit pointed to by a reclaim unit handle of the initially isolated type to a fourth reclaim unit pointed to by a reclaim unit handle of a same type as the initially isolated type. That is, the RUH of the II type allows data to be moved between RUs pointed to by RUHs of the same type.

The allocation module 1303 may then set K of the K-mean algorithm to the above second unmber. Next, the allocation module 1303 may cluster the plurality of USMs corresponding to the plurality of target files using the K-mean algorithm whose K is set to the second number, to divide the plurality of target files into the second number of groups. Then, for each of the plurality of groups, the allocation module 1303 may select a reclaim unit handle of the initially isolated type from the second number of reclaim unit handles of the initially isolated type to be allocated to the each group.

In this way, in the present disclosure, when performing file writing, the characteristic of the file itself and the type of the RUH may be considered together, and a better balance may be achieved between reducing write amplification and improving space utilization

[symbol]

The write module 1304 may write the each target file into the reclaim unit pointed to by the reclaim unit handle allocated to the each target file.

According to one or more exemplary embodiments of the present disclosure, the above apparatus 1300 of writing file may further include a proportion detection module and a dynamic adjustment module.

The proportion detection module may also detect, every preset time interval, a first proportion of target files of a short-time open file type among the plurality of target files, and/or, detect a second proportion of target files of a long-time open file type among the plurality of target files. The dynamic adjustment module may then dynamically adjust the number d based on the first proportion and/or the second proportion; wherein the smaller the first proportion is, the smaller the number d is; and the larger the second proportion is, the smaller the number d is

[symbol]

In this way, by flexibly adjusting a number of RUHs of each type based on the number proportions of files of various types, it may be ensured that the RUHs of various types may satisfy the actual file writing demand, avoiding the phenomenon that RUH of one type is in short supply while another type of RUH is in surplus, and it may be ensured that the RUH resources are reasonably utilized.

FIG. 14 is a block diagram illustrating an electronic device 1400 according to one or more exemplary embodiments of the present disclosure.

Referring to FIG. 14, the electronic device 1400 includes at least one memory 1401 and at least one processor 1402, the at least one memory 1401 has instructions stored therein, which, when executed by the at least one processor 1402, perform a method of writing file according to one or more exemplary embodiments of the present disclosure.

As one or more examples, the electronic device 1400 may be a PC computer, a tablet device, a personal digital assistant, a smart phone, or any other device capable of executing the above instructions. Here, the electronic device 1400 does not have to be a single electronic device, but may also be any set of devices or circuits capable of executing the above instructions (or instruction set) individually or jointly. The electronic device 1400 may also be a part of an integrated control system or system manager, or may be configured as a portable electronic device that interfaces locally or remotely (e.g., via wireless transmission).

In the electronic device 1400, the processor 1402 may include a central processing unit (CPU), a graphics processor (GPU), a programmable logic device, a dedicated processor system, a microcontroller, or a microprocessor. By way of example and not limitation, the processor may also include an analog processor, a digital processor, a microprocessor, a multi-core processor, a processor array, a network processor, and the like.

The processor 1402 may run instructions or code stored in the memory 1401, wherein the memory 1401 may also store data. The instructions and data may also be sent and received over a network via a network interface device, wherein the network interface device may utilize any known transmission protocol.

The memory 1401 may be integrated with the processor 1402, e.g., a RAM or flash memory is arranged within an integrated circuit microprocessor or the like.

Additionally, the memory 1401 may include a separate device such as an external disk drive, storage array, or any other storage device that may be used by a database system. The memory 1401 and the processor 1402 may be operatively coupled, or may communicate with each other, e.g., through I/O ports, network connections, etc., to enable the processor 1402 to read files stored in the memory 1401.

In addition, the electronic device 1400 may also include video displays (e.g. liquid crystal display) and user interaction interfaces (e.g. keyboard, mouse, touch input device, etc.). All components of the electronic device 1400 may be connected to each other via a bus and/or a network.

According to one or more exemplary embodiments of the present disclosure, a computer readable storage medium is also provided. Instructions in the computer readable storage medium, when executed by a processor of an electronic device, cause the processor to perform the above method of writing file. Examples of computer-readable storage media herein include: Read Only Memory (ROM), Random Access Programmable Read Only Memory (RAPROM), Electrically Erasable Programmable Read Only Memory (EEPROM), Random Access Memory (RAM), Dynamic Random Access Memory (DRAM), Static Random Access Memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blue-ray or optical disk storage, Hard Disk Drive (HDD), Solid State Drive (SSD), card storage (such as multimedia cards, secure digital (SD) cards or extremely fast digital (XD) cards), magnetic tapes, floppy disks, magneto-optical data storage devices, optical data storage devices, hard disks, solid state disks, and any other devices that are configured to store computer programs and any associated data, data files and data structures in a non-transitory manner and provide the computer programs and any associated data, data files and data structures to a processor or computer so that the processor or computer can execute the computer programs. The instructions or computer programs in the computer-readable storage medium described above may be executed in an environment deployed in a computer device. In addition, in one example, the computer programs and any associated data, data files, and data structures are distributed on a networked computer system, so that the computer programs and any associated data, data files, and data structures are stored, accessed and executed through one or more processors or computers in a distributed manner.

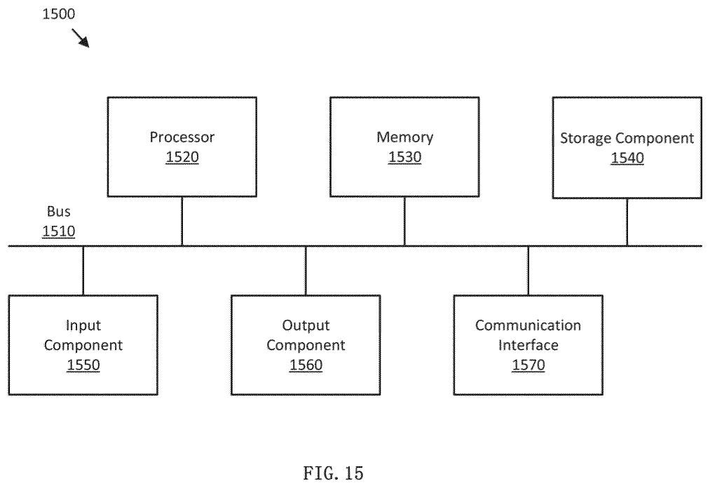

FIG. 15 is a block diagram of an example computer system, in accordance with embodiments of the present disclosure.

FIG. 15 is a block diagram of example components of one or more devices of FIG. 1. The device 1500 may correspond to the apparatus 1300 (FIG. 13) and the electronic device 1400 (FIG. 14). As shown in FIG. 15, the device 1500 may include a bus 1510, a processor 1520, a memory 1530, a storage component 1540, an input component 1550, an output component 1560, and a communication interface 1570.

The bus 1510 includes a component that permits communication among the components of the device 1500. The processor 1520 is implemented in hardware, firmware, or a combination of hardware and software. The processor 1520 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 1520 includes one or more processors capable of being programmed to perform a function. The memory 1530 includes a random access memory (RAM), a read only memory (ROM), and/or another type of dynamic or static storage device (e.g. a flash memory, a magnetic memory, and/or an optical memory) that stores information and/or instructions for use by the processor 1520.

The storage component 1540 stores information and/or software related to the operation and use of the device 1500. For example, the storage component 1540 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 1550 includes a component that permits the device 1500 to receive information, such as via user input (e.g. a touch screen display, a keyboard, a keypad, a mouse, a button, a switch, and/or a microphone). Additionally, or alternatively, the input component 1550 may include a sensor for sensing information (e.g. a global positioning system (GPS) component, an accelerometer, a gyroscope, and/or an actuator). The output component 1560 includes a component that provides output information from the device 1500 (e.g. a display, a speaker, and/or one or more light-emitting diodes (LEDs)).

The communication interface 1570 includes a transceiver-like component (e.g., a transceiver and/or a separate receiver and transmitter) that enables the device 1500 to communicate with other devices, such as via a wired connection, a wireless connection, or a combination of wired and wireless connections. The communication interface 1570 may permit the device 1500 to receive information from another device and/or provide information to another device. For example, the communication interface 1570 may include an Ethernet interface, an optical interface, a coaxial interface, an infrared interface, a radio frequency (RF) interface, a universal serial bus (USB) interface, a Wi-Fi interface, a cellular network interface, or the like.

The device 1500 may perform one or more processes described herein. The device 1500 may perform these processes in response to the processor 1520 executing software instructions stored by a non-transitory computer-readable medium, such as the memory 1530 and/or the storage component 1540. A computer-readable medium is defined herein as a non-transitory memory device. A memory device includes memory space within a single physical storage device or memory space spread across multiple physical storage devices.

Software instructions may be read into the memory 1530 and/or the storage component 1540 from another computer-readable medium or from another device via the communication interface 1570. When executed, software instructions stored in the memory 1530 and/or the storage component 1540 may cause the processor 1520 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 15 are provided as an example. In practice, the device 1500 may include additional components, fewer components, different components, or differently arranged components than those shown in FIG. 15. Additionally, or alternatively, a set of components (e.g. one or more components) of the device 1500 may perform one or more functions described as being performed by another set of components of the device 1500.

According to one or more exemplary embodiments of the present disclosure, there is provided a computer program product including a computer program, wherein the computer program, when executed by a processor, implements a method of writing file according to the present disclosure.

According to the method and apparatus of writing file, the electronic device, the computer program and the storage medium of the present disclosure, since the differences between the failure times of the individual files contained in the reclaim unit pointed to by the same reclaim unit handle may be smaller than the preset threshold value, i.e., since the failure times of the individual files written into the same RU may be approximately same as far as possible, synchronous erasure of the individual files contained in the same RU may be realized when garbage collection is performed, and write amplification due to simultaneous existence of both invalid and valid data in the same RU may be avoided. Thus, the method provided by the present disclosure may reduce the degree of fragmentation of the files contained in the RU, which in turn reduces write overhead.

According to the exemplary embodiments of the present disclosure, since the user may set the proportions of RUHs of various types according to the actual situations, the autonomy and flexibility of setting the proportions of RUHs of various types is better.

According to the exemplary embodiments of the present disclosure, when performing file writing, the characteristic of the file itself and the type of the RUH may be considered together, and a better balance may be achieved between reducing write amplification and improving space utilization.

According to the exemplary embodiments of the present disclosure, by flexibly adjusting the number of RUH of each type based on the number proportions of files of various types, it may be ensured that the RUHs of various types may satisfy the actual file writing demand, avoiding the phenomenon that RUH of one type is in short supply while RUH of another type is in surplus, and it may be ensured that the RUH resources are reasonably utilized.

According to an aspect of the disclosure, a method of writing a file, includes: acquiring a plurality of target files to be written; determining, for each of the plurality of target files, a feature value associated with a file failure time of each of the plurality of target files; allocating a reclaim circuit handler to each target file based on the feature value of each target file such that differences between failure times of individual files contained in a reclaim circuit pointed to by the reclaim circuit handler are less than a preset threshold value, each reclaim circuit handler being one of a preset plurality of reclaim circuit handlers; and writing each target file into the reclaim circuit pointed to by the reclaim circuit handler allocated to each target file.

According to an aspect of the disclosure, before allocating the reclaim circuit handler to each target file based on the feature value of each target file, the method further includes: determining a file type of each of the plurality of target files, wherein the file type is one of a short-time open file type and a long-time open file type, and wherein the allocating the reclaim circuit handler to each target file based on the feature value of each target file includes: allocating the reclaim circuit handler to each target file based on the feature value and the file type of each target file.

According to an aspect of the disclosure, the determining the file type of each of the plurality of target files includes: setting the file type of each target file to the short-time open file type as a default file type; detecting, at every preset time interval, whether each target file is in an open state; converting the file type of one or more target files from the short-time open file type to the long-time open file type based on detecting that the one or more target files are in the open state.

According to an aspect of the disclosure, the allocating the reclaim circuit handler to each target file based on the feature value and the file type of each target file includes: based on determining a file type of a target file is the short-time open file type, inputting the feature value of each target file of the short-time open file type into a random forest model to obtain a predicted lifetime of each target file; calculating a failure time of each target file based on a creation time and the predicted lifetime of each target file; allocating a reclaim circuit handler of a persistently isolated type to each target file based on the failure time of each target file and a failure time of a currently existing file in a reclaim circuit pointed to by each of the preset plurality of reclaim circuit handlers, wherein the reclaim circuit handler of the persistently isolated type is configured to enable a file to be moved from a first reclaim circuit pointed to by a reclaim circuit handler of the persistently isolated type to a second reclaim circuit pointed to by the reclaim circuit handler of the persistently isolated type.

According to an aspect of the disclosure, the allocating the reclaim circuit handler of the persistently isolated type to each target file based on the failure time of each target file and the failure time of the currently existing file in the reclaim circuit pointed to by each of the preset plurality of reclaim circuit handlers includes: calculating, for each of a first number of reclaim circuit handlers of the persistently isolated type contained in the preset plurality of reclaim circuit handlers, a mean square error between the failure time of each target file and a failure time of a currently existing file in a reclaim circuit pointed to by each reclaim circuit handler of the persistently isolated type; determining, among the first number of reclaim circuit handlers of the persistently isolated type, a corresponding reclaim circuit handler of the persistently isolated type with a lowest mean square error for each target file; allocating, to each target file, the corresponding reclaim circuit handler of the persistently isolated type with the lowest mean square error.

According to an aspect of the disclosure, based on determining the file type of the target file is the short-time open file type, the feature value of the target file comprises at least one of: a creation time of the target file, a size of the target file, a number of files of which open times are close to an open time of the target file under each of the preset plurality of reclaim circuit handlers, an average lifetime of files of which file types are same as the file type of the target file and which have been deleted under each preset reclaim circuit handler.

According to an aspect of the disclosure, based on determining a file type of a target file is the long-time open file type, the feature value is a unit size modification (USM), the USM being a ratio of (i) a number of times the target file has been modified to (ii) a size of the target file, and the allocating the reclaim circuit handler to each target file based on the feature value and the file type of each target file includes: clustering a plurality of USMs corresponding to the plurality of target files using a K-mean algorithm to divide the plurality of target files into a plurality of groups; allocating a reclaim circuit handler from the preset plurality of reclaim circuit handlers to each of the plurality of groups.

According to an aspect of the disclosure, the clustering the plurality of USMs corresponding to the plurality of target files using the K-mean algorithm to divide the plurality of target files into the plurality of groups includes: determining a second number of reclaim circuit handlers of an initially isolated type among the preset plurality of reclaim circuit handlers, wherein the reclaim circuit handler of the initially isolated type is configured to enable a file to be moved from a third reclaim circuit pointed to by a reclaim circuit handler of the initially isolated type to a fourth reclaim circuit pointed to by a reclaim circuit handler of a same type as the initially isolated type; setting K of the K-mean algorithm to the second number; clustering the plurality of USMs corresponding to the plurality of target files using the K-mean algorithm whose K is set to the second number, to divide the plurality of target files into the K number of groups; the allocating the reclaim circuit handler to each of the plurality of groups, includes: selecting, for each of the plurality of groups, a reclaim circuit handler of the initially isolated type from the second number of reclaim circuit handlers of the initially isolated type to be allocated to each group.

According to an aspect of the disclosure, a total number of the preset plurality of reclaim circuit handlers is N; before acquiring the plurality of target files to be written, the method further includes: in response to a setting input from a user, setting a number of reclaim circuit handlers whose handler type is a persistently isolated type to d, and setting a number of reclaim circuit handlers whose handler type is an initially isolated type to (N-d), wherein N and d are positive integers.

According to an aspect of the disclosure, the method further includes: detecting, every preset time interval, a first proportion of target files of a short-time open file type among the plurality of target files, or, detecting a second proportion of target files of a long-time open file type among the plurality of target files; and dynamically adjusting the number d based on the first proportion or the second proportion, wherein the number d is proportional to the first proportion is, and the number d is inversely proportional to the second proportion.

According to an aspect of the disclosure, an apparatus of writing a file, includes: a memory configured to store one or more instructions; and a processor operatively coupled to the memory and configured to execute the one or more instructions stored in the memory, wherein the one or more instructions, when executed by the processor, cause the apparatus to: acquire a plurality of target files to be written, determine, for each of the plurality of target files, a feature value associated with a file failure time of each of the plurality of target files, allocate a reclaim circuit handler to each target file based on the feature value of each target file, such that differences between failure times of individual files contained in a reclaim circuit pointed to by the reclaim circuit handler are less than a preset threshold value, each reclaim circuit handler being one of a preset plurality of reclaim circuit handlers, and write each target file into the reclaim circuit pointed to by the reclaim circuit handler allocated to each target file.

According to an aspect of the disclosure, the one or more instructions, when executed by the processor, cause the apparatus to: before, the reclaim circuit handler is allocated to each target file, determine a file type of each of the plurality of target files, wherein the file type is one of a short-time open file type and a long-time open file type, and allocate the reclaim circuit handler to each target file based on the feature value and the file type of each target file.

According to an aspect of the disclosure, the one or more instructions, when executed by the processor, cause the apparatus to: set the file type of each target file to the short-time open file type as a default file type, detect, at every preset time interval, whether each target file is in an open state every preset time interval, and convert the file type of one or more target files from the short-time open file type to the long-time open file type based on detecting that the one or more target files are in the open state.

According to an aspect of the disclosure, the one or more instructions, when executed by the processor, cause the apparatus to: based on determining a file type of a target file is the short-time open file type, input the feature value of each target file of the short-time open file type into a random forest model to obtain a predicted lifetime of each target file, calculate a failure time of each target file based on a creation time and the predicted lifetime of each target file, and allocate a reclaim circuit handler of a persistently isolated type to each target file based on the failure time of each target file and a failure time of a currently existing file in a reclaim circuit pointed to by each of the preset plurality of reclaim circuit handlers, wherein the reclaim circuit handler of the persistently isolated type is configured to enable a file to be moved from a first reclaim circuit pointed to by a reclaim circuit handler of the persistently isolated type to a second reclaim circuit pointed to by the reclaim circuit handler of the persistently isolated type.

According to an aspect of the disclosure, the one or more instructions, when executed by the processor, cause the apparatus to: calculate, for each of a first number of reclaim circuit handlers of the persistently isolated type contained in the preset plurality of reclaim circuit handlers, a mean square error between the failure time of each target file and a failure time of a currently existing file in a reclaim circuit pointed to by each reclaim circuit handler of the persistently isolated type, determine, among the first number of reclaim circuit handlers of the persistently isolated type, a corresponding reclaim circuit handler of the persistently isolated type with a lowest mean square error for each target file, and allocate, to each target file, the corresponding reclaim circuit handler of the persistently isolated type with the lowest mean square error.

According to an aspect of the disclosure, based on determining the file type of the target file is the short-time open file type, the feature value of the target file comprises at least one of: a creation time of the target file, a size of the target file, a number of files of which open times are close to an open time of the target file under each of the preset plurality of reclaim circuit handlers, an average lifetime of files of which file types are same as the file type of the target file and which have been deleted under each preset reclaim circuit handler.

According to an aspect of the disclosure, based on determining the file type of the target file is the long-time open file type, the feature value is a unit size modification (USM), the USM being a ratio of (i) a number of times the target file has been modified to (ii) a size of the target file, wherein the one or more instructions, when executed by the processor, cause the apparatus to: cluster a plurality of USMs corresponding to the plurality of target files using a K-mean algorithm to divide the plurality of target files into a plurality of groups, and allocate a reclaim circuit handler from the preset plurality of reclaim circuit handlers to each of the plurality of groups.

According to an aspect of the disclosure, the one or more instructions, when executed by the processor, cause the apparatus to: determine a second number of reclaim circuit handlers of an initially isolated type among the preset plurality of reclaim circuit handlers, wherein the reclaim circuit handler of the initially isolated type allows for a file to be moved from a third reclaim circuit pointed to by a reclaim circuit handler of the initially isolated type to a fourth reclaim circuit pointed to by a reclaim circuit handler of a same type as the initially isolated type, set K of the K-mean algorithm to the second number, cluster the plurality of USMs corresponding to the plurality of target files using the K-mean algorithm whose K is set to the second number, to divide the plurality of target files into the K number of groups, and select, for each of the plurality of groups, a reclaim circuit handler of the initially isolated type from the second number of reclaim circuit handlers of the initially isolated type to be allocated to each group.

According to an aspect of the disclosure, wherein a total number of the preset plurality of reclaim circuit handlers is N, wherein the one or more instructions, when executed by the processor, cause the apparatus to: in response to a setting input from a user, set a number of reclaim circuit handlers whose handler type is a persistently isolated type to d, and set a number of reclaim circuit handlers whose handler type is an initially isolated type to (N-d), and wherein N and d are positive integers.

According to an aspect of the disclosure, wherein the one or more instructions, when executed by the processor, cause the apparatus to: detect, every preset time interval, a first proportion of target files of a short-time open file type among the plurality of target files, and/or, detect a second proportion of target files of a long-time open file type among the plurality of target files, dynamically adjust the number d based on the first proportion and/or the second proportion, wherein the number d is proportional to the first proportion is, and the number d is inversely proportional to the second proportion.

According to an aspect of the disclosure, an electronic device includes: a memory storing one or more instructions; and a processor operatively coupled to the memory and configured to execute the one or more instructions stored in the memory, wherein the one or more instructions, when executed by the processor, cause the electronic device to: acquire a plurality of target files to be written, predict, for each of the plurality of target files, a file failure time of each of the plurality of target files, allocate a reclaim circuit handler to each target file based on the file failure time of each target file such that differences between failure times of individual files contained in a reclaim circuit pointed to by the reclaim circuit handler are less than a preset threshold value, each reclaim circuit handler being one of a preset plurality of reclaim circuit handlers, and write each target file into the reclaim circuit pointed to by the reclaim circuit handler allocated to each target file.

According to an aspect of the disclosure, a non-transitory computer readable storage medium, having instructions stored therein, which when executed by a processor of an electronic device, cause the electronic device to execute a method including: acquiring a plurality of target files to be written; determining, for each of the plurality of target files, a feature value associated with a file failure time of each of the plurality of target files; allocating a reclaim circuit handler to each target file based on the feature value of each target file such that differences between failure times of individual files contained in a reclaim circuit pointed to by the reclaim circuit handler are less than a preset threshold value, each reclaim circuit handler being one of a preset plurality of reclaim circuit handlers; writing each target file into the reclaim circuit pointed to by the reclaim circuit handler allocated to each target file.

After considering the specification and the practice of the invention disclosed herein, those skilled in the art will readily conceive of other implementations of the present disclosure. The present disclosure is intended to cover any variation, use or adaptation of the present disclosure that follows the general principles of the present disclosure and includes the common knowledge or customary technical means in the field of technology not disclosed by the present disclosure. The specification and embodiments are deemed to be exemplary only, and the true scope and spirit of the present disclosure are indicated by the appended claims.

It should be understood that the present disclosure is not limited to the precise structure already described above and shown in the attached drawings and is subject to various modifications and changes within its scope. The scope of the present disclosure is limited only by the attached claims.

1. A method of writing a file, comprising:
acquiring a plurality of target files to be written;
determining, for each of the plurality of target files, a feature value associated with a file failure time of each of the plurality of target files;
allocating a reclaim circuit handler to each target file based on the feature value of each target file such that differences between failure times of individual files contained in a reclaim circuit pointed to by the reclaim circuit handler are less than a preset threshold value, each reclaim circuit handler being one of a preset plurality of reclaim circuit handlers; and
writing each target file into the reclaim circuit pointed to by the reclaim circuit handler allocated to each target file.

2. The method as claimed in claim 1, wherein before allocating the reclaim circuit handler to each target file based on the feature value of each target file, the method further comprises:
determining a file type of each of the plurality of target files, wherein the file type is one of a short-time open file type and a long-time open file type, and
wherein the allocating the reclaim circuit handler to each target file based on the feature value of each target file comprises:
allocating the reclaim circuit handler to each target file based on the feature value and the file type of each target file.

3. The method as claimed in claim 2, wherein the determining the file type of each of the plurality of target files comprises:
setting the file type of each target file to the short-time open file type as a default file type;
detecting, at every preset time interval, whether each target file is in an open state;
converting the file type of one or more target files from the short-time open file type to the long-time open file type based on detecting that the one or more target files are in the open state.

4. The method as claimed in claim 2, wherein the allocating the reclaim circuit handler to each target file based on the feature value and the file type of each target file comprises:
based on determining a file type of a target file is the short-time open file type, inputting the feature value of each target file of the short-time open file type into a random forest model to obtain a predicted lifetime of each target file;
calculating a failure time of each target file based on a creation time and the predicted lifetime of each target file;
allocating a reclaim circuit handler of a persistently isolated type to each target file based on the failure time of each target file and a failure time of a currently existing file in a reclaim circuit pointed to by each of the preset plurality of reclaim circuit handlers, wherein the reclaim circuit handler of the persistently isolated type is configured to enable a file to be moved from a first reclaim circuit pointed to by a reclaim circuit handler of the persistently isolated type to a second reclaim circuit pointed to by the reclaim circuit handler of the persistently isolated type.

5. The method as claimed in claim 4, wherein the allocating the reclaim circuit handler of the persistently isolated type to each target file based on the failure time of each target file and the failure time of the currently existing file in the reclaim circuit pointed to by each of the preset plurality of reclaim circuit handlers comprises:
calculating, for each of a first number of reclaim circuit handlers of the persistently isolated type contained in the preset plurality of reclaim circuit handlers, a mean square error between the failure time of each target file and a failure time of a currently existing file in a reclaim circuit pointed to by each reclaim circuit handler of the persistently isolated type;
determining, among the first number of reclaim circuit handlers of the persistently isolated type, a corresponding reclaim circuit handler of the persistently isolated type with a lowest mean square error for each target file;
allocating, to each target file, the corresponding reclaim circuit handler of the persistently isolated type with the lowest mean square error.

6. The method as claimed in claim 4, wherein based on determining the file type of the target file is the short-time open file type, the feature value of the target file comprises at least one of:
a creation time of the target file, a size of the target file, a number of files of which open times are close to an open time of the target file under each of the preset plurality of reclaim circuit handlers, an average lifetime of files of which file types are same as the file type of the target file and which have been deleted under each preset reclaim circuit handler.

7. The method as claimed in claim 2, wherein based on determining a file type of a target file is the long-time open file type, the feature value is a unit size modification (USM), the USM being a ratio of (i) a number of times the target file has been modified to (ii) a size of the target file, and the allocating the reclaim circuit handler to each target file based on the feature value and the file type of each target file comprises:
clustering a plurality of USMs corresponding to the plurality of target files using a K-mean algorithm to divide the plurality of target files into a plurality of groups;
allocating a reclaim circuit handler from the preset plurality of reclaim circuit handlers to each of the plurality of groups.

8. The method as claimed in claim 7, wherein the clustering the plurality of USMs corresponding to the plurality of target files using the K-mean algorithm to divide the plurality of target files into the plurality of groups comprises:
determining a second number of reclaim circuit handlers of an initially isolated type among the preset plurality of reclaim circuit handlers, wherein the reclaim circuit handler of the initially isolated type is configured to enable a file to be moved from a third reclaim circuit pointed to by a reclaim circuit handler of the initially isolated type to a fourth reclaim circuit pointed to by a reclaim circuit handler of a same type as the initially isolated type;
setting K of the K-mean algorithm to the second number;
clustering the plurality of USMs corresponding to the plurality of target files using the K-mean algorithm whose K is set to the second number, to divide the plurality of target files into the K number of groups;
the allocating the reclaim circuit handler to each of the plurality of groups, comprises:
selecting, for each of the plurality of groups, a reclaim circuit handler of the initially isolated type from the second number of reclaim circuit handlers of the initially isolated type to be allocated to each group.

9. The method as claimed in claim 1, wherein a total number of the preset plurality of reclaim circuit handlers is N;
before acquiring the plurality of target files to be written, the method further comprises:
in response to a setting input from a user, setting a number of reclaim circuit handlers whose handler type is a persistently isolated type to d, and setting a number of reclaim circuit handlers whose handler type is an initially isolated type to (N-d),
wherein N and d are positive integers.

10. The method as claimed in claim 9, wherein the method further comprises:
detecting, every preset time interval, a first proportion of target files of a short-time open file type among the plurality of target files, or, detecting a second proportion of target files of a long-time open file type among the plurality of target files; and
dynamically adjusting the number d based on the first proportion or the second proportion,
wherein the number d is proportional to the first proportion, and the number d is inversely proportional to the second proportion.

11. An apparatus of writing a file, comprising:
a memory configured to store one or more instructions; and
a processor operatively coupled to the memory and configured to execute the one or more instructions stored in the memory,
wherein the one or more instructions, when executed by the processor, cause the apparatus to:
acquire a plurality of target files to be written,
determine, for each of the plurality of target files, a feature value associated with a file failure time of each of the plurality of target files,
allocate a reclaim circuit handler to each target file based on the feature value of each target file, such that differences between failure times of individual files contained in a reclaim circuit pointed to by the reclaim circuit handler are less than a preset threshold value, each reclaim circuit handler being one of a preset plurality of reclaim circuit handlers, and
write each target file into the reclaim circuit pointed to by the reclaim circuit handler allocated to each target file.

12. The apparatus as claimed in claim 11, wherein the one or more instructions, when executed by the processor, cause the apparatus to:
before, the reclaim circuit handler is allocated to each target file, determine a file type of each of the plurality of target files, wherein the file type is one of a short-time open file type and a long-time open file type, and
allocate the reclaim circuit handler to each target file based on the feature value and the file type of each target file.

13. The apparatus as claimed in claim 12, wherein the one or more instructions, when executed by the processor, cause the apparatus to:
set the file type of each target file to the short-time open file type as a default file type,
detect, at every preset time interval, whether each target file is in an open state every preset time interval, and
convert the file type of one or more target files from the short-time open file type to the long-time open file type based on detecting that the one or more target files are in the open state.

14. The apparatus as claimed in claim 12, wherein the one or more instructions, when executed by the processor, cause the apparatus to:
based on determining a file type of a target file is the short-time open file type, input the feature value of each target file of the short-time open file type into a random forest model to obtain a predicted lifetime of each target file,
calculate a failure time of each target file based on a creation time and the predicted lifetime of each target file, and
allocate a reclaim circuit handler of a persistently isolated type to each target file based on the failure time of each target file and a failure time of a currently existing file in a reclaim circuit pointed to by each of the preset plurality of reclaim circuit handlers, wherein the reclaim circuit handler of the persistently isolated type is configured to enable a file to be moved from a first reclaim circuit pointed to by a reclaim circuit handler of the persistently isolated type to a second reclaim circuit pointed to by the reclaim circuit handler of the persistently isolated type.

15. The apparatus as claimed in claim 14, wherein the one or more instructions, when executed by the processor, cause the apparatus to:
calculate, for each of a first number of reclaim circuit handlers of the persistently isolated type contained in the preset plurality of reclaim circuit handlers, a mean square error between the failure time of each target file and a failure time of a currently existing file in a reclaim circuit pointed to by each reclaim circuit handler of the persistently isolated type,
determine, among the first number of reclaim circuit handlers of the persistently isolated type, a corresponding reclaim circuit handler of the persistently isolated type with a lowest mean square error for each target file, and
allocate, to each target file, the corresponding reclaim circuit handler of the persistently isolated type with the lowest mean square error.

16. The apparatus as claimed in claim 14, wherein based on determining the file type of the target file is the short-time open file type, the feature value of the target file comprises at least one of:
a creation time of the target file, a size of the target file, a number of files of which open times are close to an open time of the target file under each of the preset plurality of reclaim circuit handlers, an average lifetime of files of which file types are same as the file type of the target file and which have been deleted under each preset reclaim circuit handler.

17. The apparatus as claimed in claim 12, wherein based on determining the file type of the target file is the long-time open file type, the feature value is a unit size modification (USM), the USM being a ratio of (i) a number of times the target file has been modified to (ii) a size of the target file, wherein the one or more instructions, when executed by the processor, cause the apparatus to:
cluster a plurality of USMs corresponding to the plurality of target files using a K-mean algorithm to divide the plurality of target files into a plurality of groups, and
allocate a reclaim circuit handler from the preset plurality of reclaim circuit handlers to each of the plurality of groups.

18. The apparatus as claimed in claim 17, wherein the one or more instructions, when executed by the processor, cause the apparatus to:
determine a second number of reclaim circuit handlers of an initially isolated type among the preset plurality of reclaim circuit handlers, wherein the reclaim circuit handler of the initially isolated type allows for a file to be moved from a third reclaim circuit pointed to by a reclaim circuit handler of the initially isolated type to a fourth reclaim circuit pointed to by a reclaim circuit handler of a same type as the initially isolated type,
set K of the K-mean algorithm to the second number,
cluster the plurality of USMs corresponding to the plurality of target files using the K-mean algorithm whose K is set to the second number, to divide the plurality of target files into the K number of groups, and
select, for each of the plurality of groups, a reclaim circuit handler of the initially isolated type from the second number of reclaim circuit handlers of the initially isolated type to be allocated to each group.

19. The apparatus as claimed in claim 11, wherein a total number of the preset plurality of reclaim circuit handlers is N,
wherein the one or more instructions, when executed by the processor, cause the apparatus to:
in response to a setting input from a user, set a number of reclaim circuit handlers whose handler type is a persistently isolated type to d, and set a number of reclaim circuit handlers whose handler type is an initially isolated type to (N-d), and
wherein N and d are positive integers.

20. (canceled)

21. An electronic device comprising:
a memory storing one or more instructions; and
a processor operatively coupled to the memory and configured to execute the one or more instructions stored in the memory,
wherein the one or more instructions, when executed by the processor, cause the electronic device to:
acquire a plurality of target files to be written,
predict, for each of the plurality of target files, a file failure time of each of the plurality of target files,
allocate a reclaim circuit handler to each target file based on the file failure time of each target file such that differences between failure times of individual files contained in a reclaim circuit pointed to by the reclaim circuit handler are less than a preset threshold value, each reclaim circuit handler being one of a preset plurality of reclaim circuit handlers, and
write each target file into the reclaim circuit pointed to by the reclaim circuit handler allocated to each target file.

22. (canceled)
